(19) United States
(12) Patent Application Publication
(10) Pub. No.: US 2026/0065738 A1
(43) Pub. Date: Mar. 5, 2026

(54) PLAYER LOYALTY SYSTEM WITH RAPID TAP GAMING INTERFACE

(71) Applicant: Everi Games Inc., Austin, TX (US)

(72) Inventors: Daniel Adrover, Pflugerville, TX (US); Connor Yarnott, River Falls, WI (US); Derek Smith, Las Vegas, NV (US); Brian Kattlegreen, Clawson, MI (US); Derek Bryant, Las Vegas, NV (US)

(73) Assignee: Everi Games Inc., Austin, TX (US)

(21) Appl. No.: 18/818,471

(22) Filed: Aug. 28, 2024

(51) Int. Cl. G07F 17/32

(52) U.S. Cl. CPC G07F 17/3213; G07F 17/3209; G07F 17/3239; G07F 17/3255

(57) ABSTRACT

A player loyalty kiosk, system, method, and program product provide a loyalty game machine game with an enhanced player interface. A display system of the player loyalty kiosk displays the gaming interface including an animated game effect in a first area of the display system with one or more moving elements. Responsive to a player input a player input rate measurement is adjusted based on a rate of player inputs over time. A velocity of a first one of the moving elements is adjusted based on the player rate input measurement and adjusting a conclusion of the animated game effect based at least in part on the movement of the adjusted moving element.

### FIELD OF THE INVENTION

This invention relates to casino player loyalty systems and interfaces to casino systems.

### BACKGROUND

Casino gaming networks often host a variety of slot machines at a casino site, and may provide remote gaming available in designated locations via smartphone applications or websites, with a backend server at the casino connecting the remote gaming device to the casino. Casino gaming networks also include player loyalty systems, which track players participation and provide promotions and other benefits in response to players meeting designated levels of participation. These levels may relate to amounts wagered through the casino or remote gaming, frequency of gaming, playing a number of different types of games, and other metrics which a casino provider may track relating to player activity.

Player loyalty systems often use a player loyalty kiosk placed in a casino for players to enroll in the system, obtain a player card, and interact with various features of the system to perform functions such as claiming promotional awards. Some of the features of a player loyalty kiosk may also be made available over a website or mobile application providing a remote, secure interface to the player loyalty system. In some cases, a player loyalty kiosk can also take deposits to allow players to add money to their slot machine credit accounts for play. A player loyalty kiosk may also be integrated with an ATM machine.

Casino gaming system manufacturers are continuously pressed to develop new ways to engage players with player loyalty systems, providing features such as loyalty games for which promotions and comps are awarded and loyalty groups which players participate in to obtain special features or comps, in an attempt to provide high entertainment value for players and thereby attract and keep players.

### SUMMARY OF THE INVENTION

The present invention encompasses a player loyalty system for a slot machine network, and a player loyalty kiosk, method, and program product, which provide a gaming interface for a player loyalty system. A player loyalty kiosk, system, method, and program product provide a loyalty game machine game with an enhanced player interface. A display system of the player loyalty kiosk displays the gaming interface including an animated game effect in a first area of the display system with one or more moving elements. Responsive to a player input a player input rate measurement is adjusted based on a rate of player inputs over time. A velocity of a first one of the moving elements is adjusted based on the player rate input measurement and adjusting a conclusion of the animated game effect based at least in part on the movement of the adjusted moving element.

According to one aspect of the invention, a player loyalty system for a slot machine network includes a player loyalty server and a player loyalty kiosk. The player loyalty server is operable to track player loyalty points on the slot machine network, provide awards and promotions accessible through a player loyalty interface, and provide player loyalty game results accessible through a gaming interface of the player loyalty interface. The player loyalty kiosk is coupled to the player loyalty server over a network, and includes a controller, a touchscreen display system coupled to the controller, a player card reader coupled to the controller, and one or more tangible non-transitory computer readable media holding a program product containing instructions for controlling operation of the player loyalty kiosk. The program instructions are executable for presenting an option through the touchscreen display to launch a player loyalty game, and responsive to a launch input entered through a gaming interface of the player loyalty kiosk, causing a display system of the player loyalty kiosk to display the gaming interface including an animated game effect in a first area of the display system with one or more moving elements. Responsive to a player input, the program instructions obtain a player input rate measurement based on a rate of player inputs over time, and adjust a velocity of a first one of the moving elements based on the player rate input measurement and adjusting a conclusion of the animated game effect based at least in part on the movement of said adjusted moving element.

According to another aspect of the invention, a method is provided for controlling operation of a player loyalty kiosk. The method includes, responsive to a game launch input entered through a user interface of the player loyalty kiosk, causing a display system of the player loyalty kiosk to display a gaming interface including an animated game effect in a first area of the display system with one or more moving elements. Responsive to a player input, the method includes adjusting a player input rate measurement based on a rate of player inputs over time. The method also includes adjusting a velocity of a first one of the moving elements based on the player rate input measurement and adjusting a conclusion of the animated game effect based at least in part on the movement of said adjusted moving element.

Another aspect of the invention is a computer program stored on one or more non-transitory computer readable medium. The software version is, of course, typically designed to be executed by a gaming machine or networked gaming system to perform one of more of the methods described herein. The software includes multiple portions of computer executable code referred to as program code. Gaming results are provided in response to activations and displayed by display program code that generates simulated slot reels each including one or more symbol locations. The program also has game controller program code for determining game play results involving operating the gaming machine according to the methods above.

According to another aspect, the invention is embodied as a player loyalty kiosk programmed to include the functionality described with respect to the method.

According to some implementations of the above aspects of the invention, a time decay adjustment is performed for the player input rate measurement such that the velocity of the first moving element decelerates more slowly than a slowdown in the player input rate measurement.

According to some implementations of the above aspects of the invention, there are two or more moving elements, and a velocity of a second one of the moving elements is adjusted based on the player rate measurement. The first moving element is provided with a base velocity which is used in the animated game effect if the player input rate measurement is zero.

According to some implementations of the above aspects of the invention, a start button is displayed, and responsive to a press of the start button, the start button is changed to a player input button, activations of which form the basis of the player input rate measurement.

According to some implementations of the above aspects of the invention, the kiosk accesses a player loyalty server to obtain a total prize amount in free play credits for the game result, and selecting a game result presenting the prize amount from among a number of game results.

The various functionality described herein may be distributed between the player loyalty kiosk and the player loyalty server in any practically functional way. For example, the current preferred architecture is for the server to determine the prize award and the player loyalty kiosk or gaming machine to determine all aspects of game logic, game outcome generation, random number generation, and presentation. However, other embodiments of course might use a thin client architecture in which the animation is also conducted by the server and the player loyalty kiosk or gaming machine serves merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1-FIG. 5 are a series of game screen diagram illustrating a primary display of a player loyalty kiosk on which a player interface is presenting an opening graphic sequence of a game according to an example embodiment.

FIG. 6A-FIG. 6H are a series of game screen diagrams on which a game interface provides a sequence of game screens following the state shown in FIG. 5.

FIG. 7 is a final game screen diagram following the state shown in FIG. 6H.

FIG. 8 is a software architecture diagram of a player loyalty system including a kiosk, a player loyalty server, and cloud services according to some embodiments.

FIG. 9 is a flow diagram of a process for providing a gaming interface and results according to some embodiments.

FIG. 10 shows a front perspective view of a player loyalty kiosk according to some embodiments.

FIG. 11 shows a hardware and logical block diagram of the player loyalty kiosk of FIG. 10.

FIG. 12 shows an example casino server network according to some embodiments.

### DETAILED DESCRIPTION OF EXAMPLE EMBODIMENTS

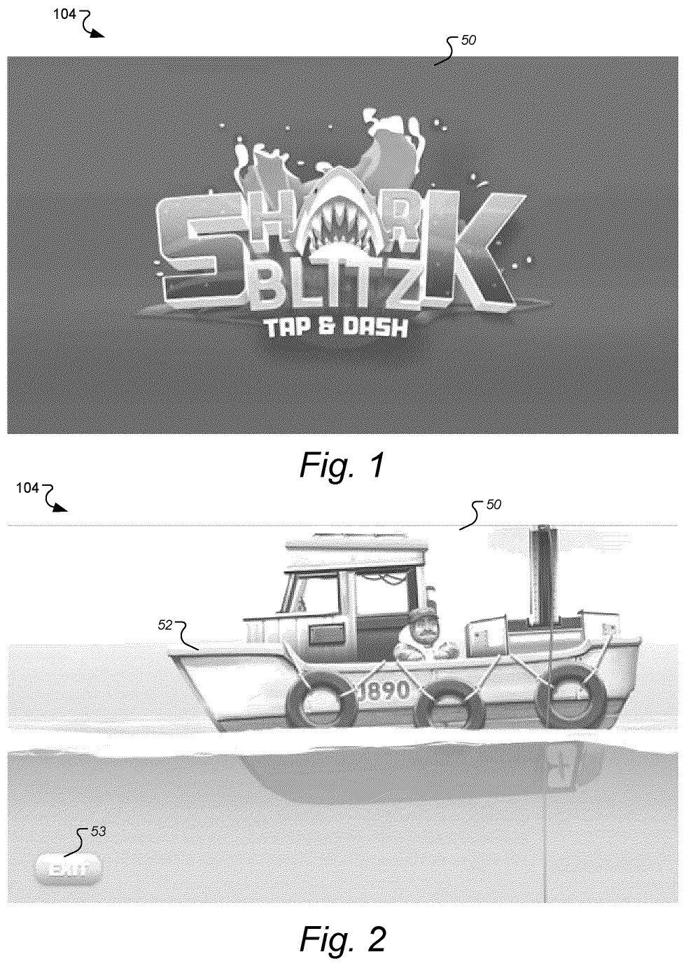

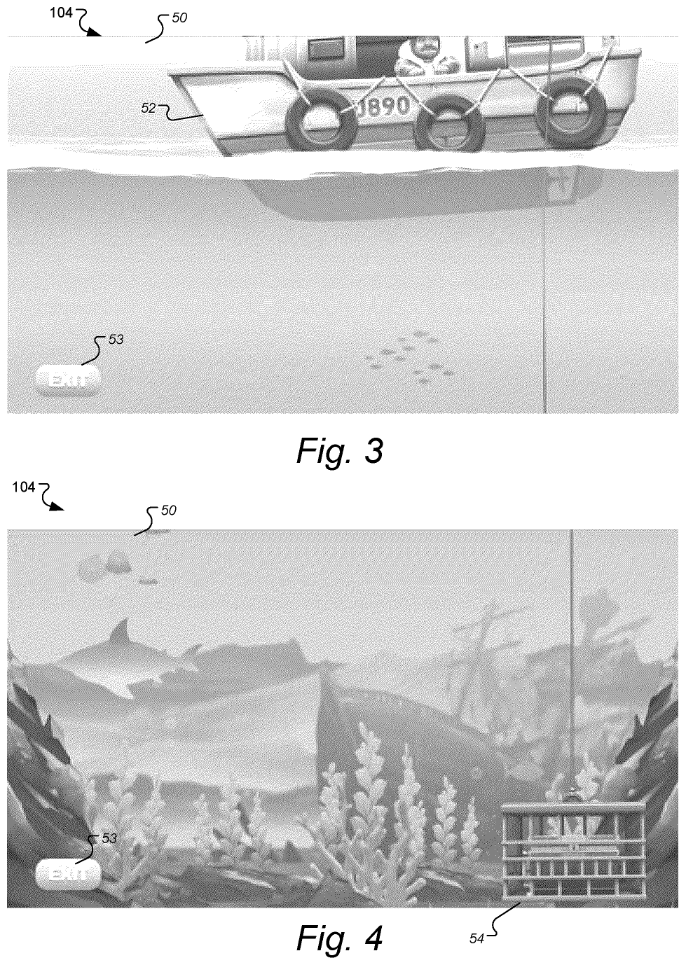

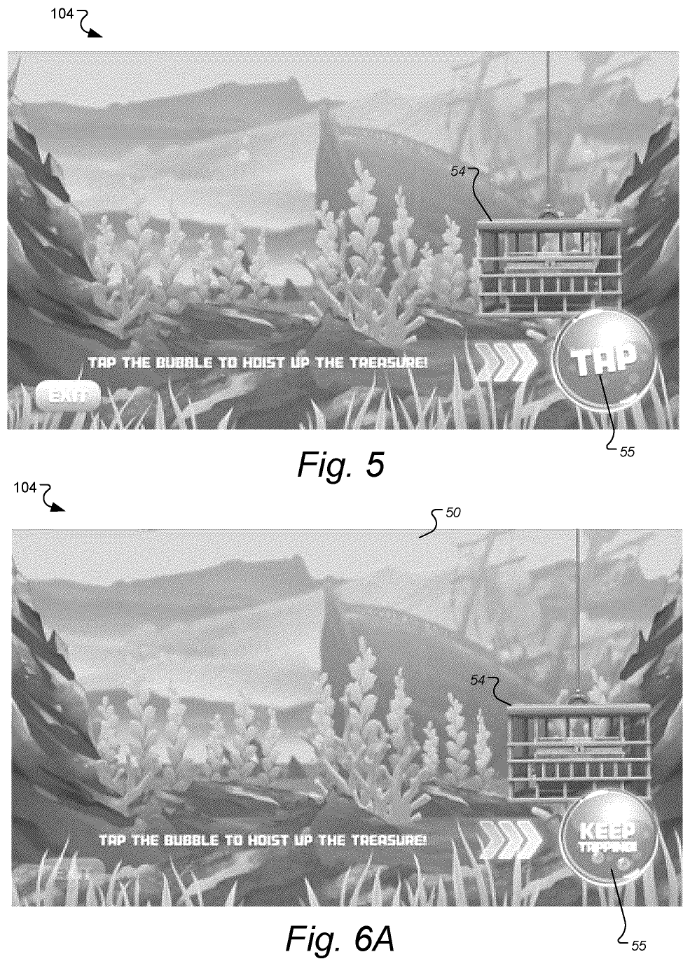

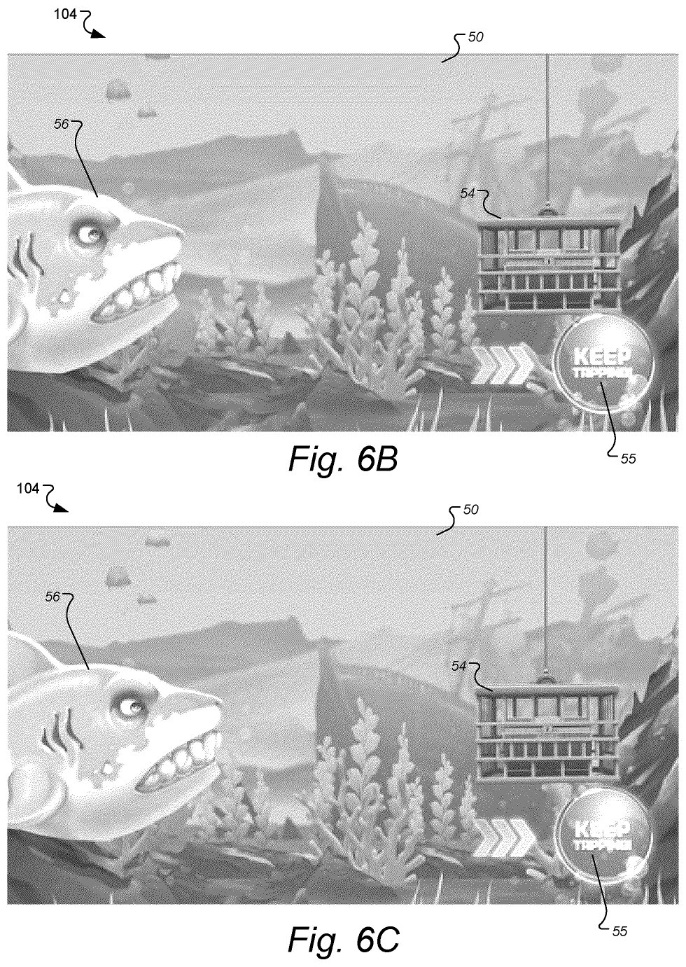

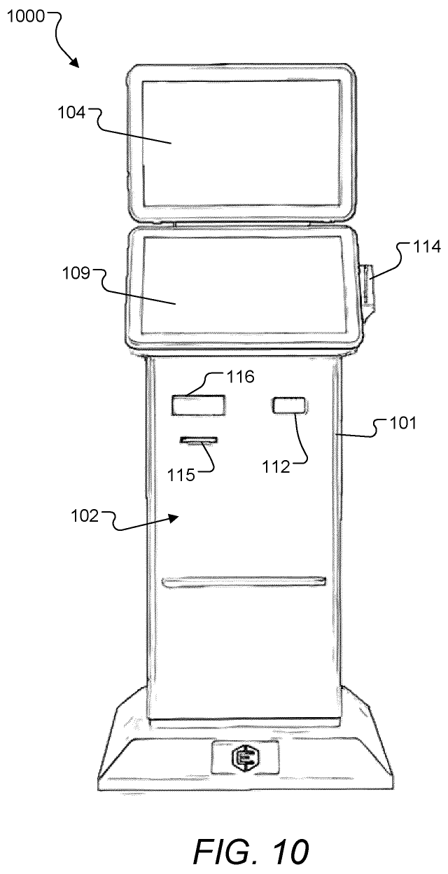

FIG. 1 is a game screen diagram illustrating a display device 104 of a player loyalty kiosk on which a game interface provides game results in primary display area 50. FIG. 2-FIG. 5 are series of game screen diagrams following FIG. 1, showing an opening sequence of a game on display device 104. In this embodiment the depicted game interface is provided as a player loyalty game interface through a player loyalty system interface kiosk (FIG. 10), while in other embodiments the game interface may be provided through a slot machine or other gaming interface device.

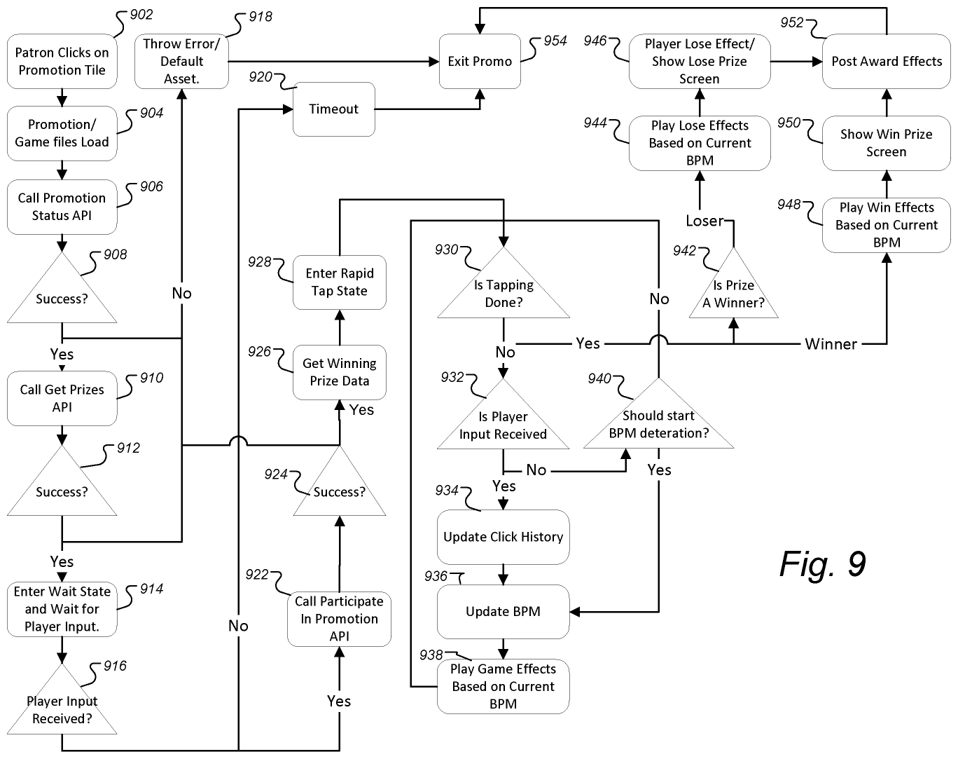

The graphic elements and other interface features will be introduced here, and the process of providing the game interface will be further described below with reference to the flowchart of FIG. 9. An exit button 53 is shown during the opening sequence, allowing the player to change their mind and exit their loyalty game before game play begins. The depicted animated image of a salvage or fishing boat 52 introduces the theme of the game employed in this example version, in which a moving element 54, a sunken treasure, is retrieved to win the game, or lost to another moving element, a shark, to lose the game, as further described below.

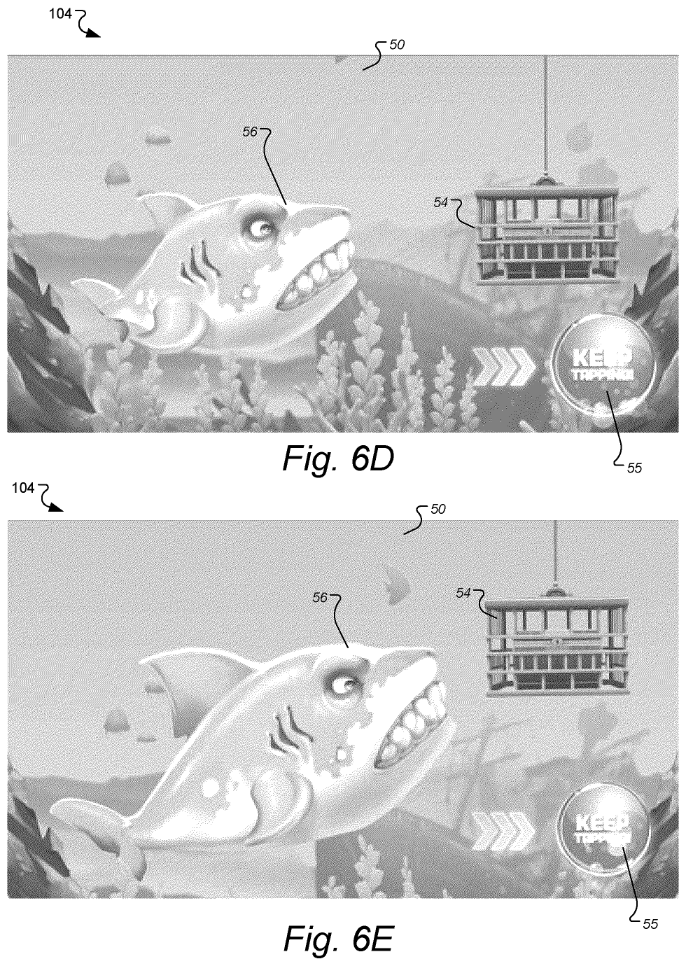

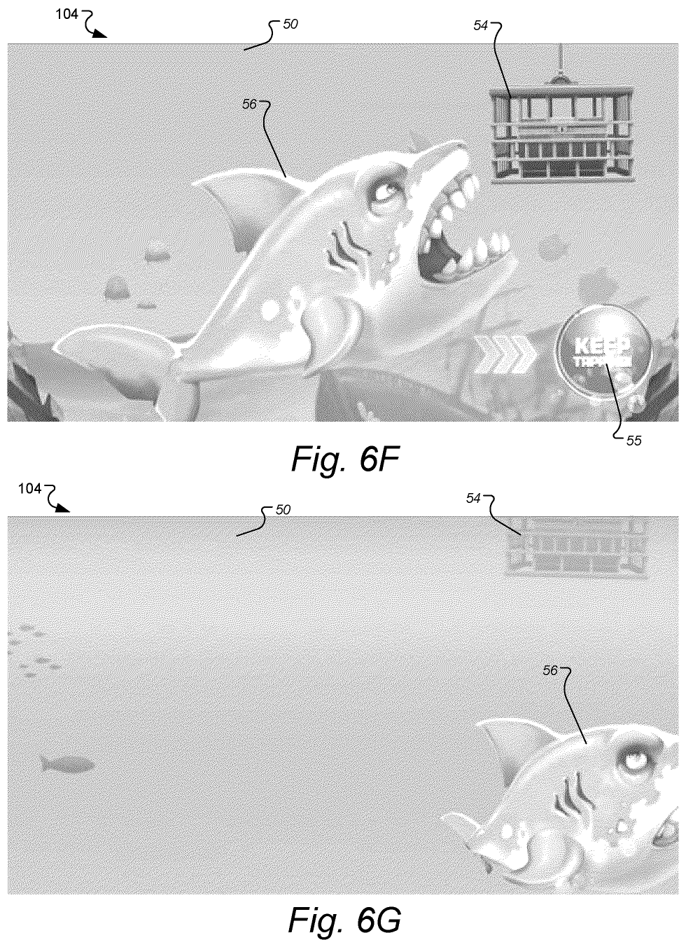

Referring to FIG. 5, at the end the introductory sequence, a text prompt and a “tap” button 55 are introduced on the display 104 to activate an interactive gaming interface. The player is prompted to tap the button to move a moving element, in this example to hoist up the depicted treasure element, first moving element 54. After the player taps, the state of button 55 is changed to show a text prompt of “keep tapping” (FIG. 6A) and speed of moving element 54 is adjusted based on the tap rate.

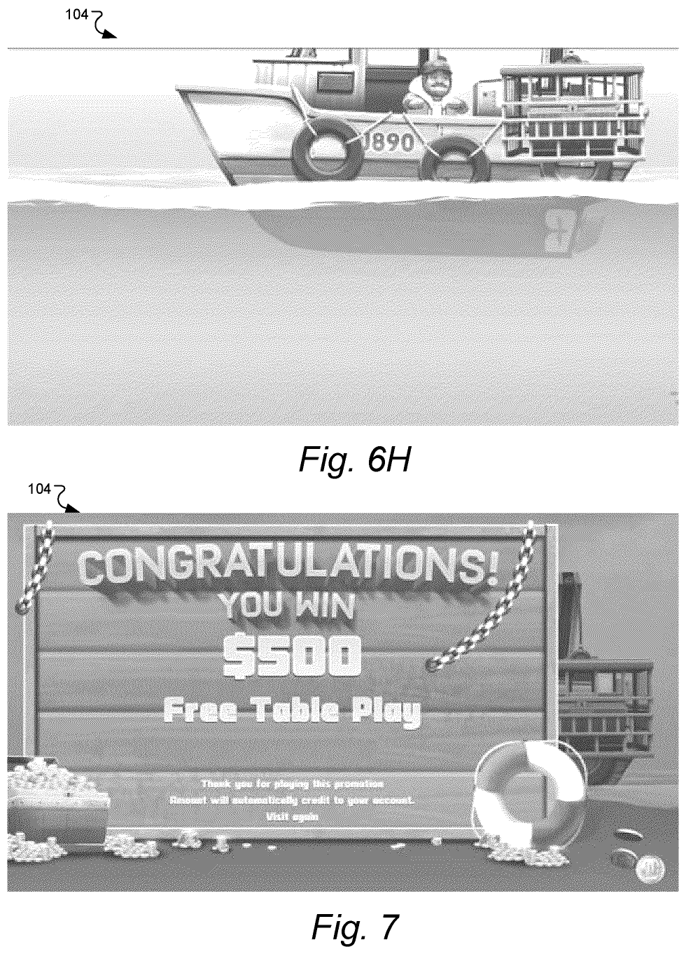

FIG. 6A-FIG. 6H are a series of game screen diagrams depicting operation of an interactive game interface to display a game result over time according to the game of FIGS. 1-5. FIG. 7 shows a final game screen appearing after the series of FIG. 6A-H to award a prize.

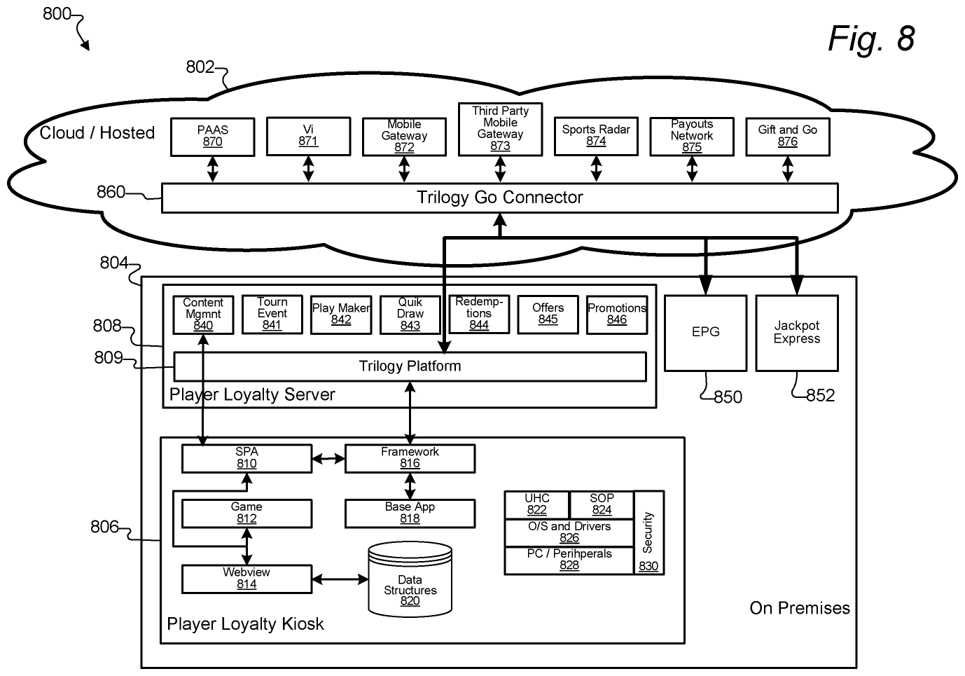

FIG. 8 is a software architecture diagram of a player loyalty system 800 according to some embodiments. System 800 is suitable for use in providing a player loyalty game as depicted above, and provides the game according the process of FIG. 9 in this embodiment. System 800 generally provides a comprehensive loyalty solution for gaming environments, integrating various components and services to enhance player engagement and provide an interactive gaming interface for loyalty games. System 800 includes both cloud/hosted components 802 and on-premises components 804, interconnected over a network through a secure VPN and platform called Trilogy in this embodiment. On-premises generally refers to a casino property, which may include multiple casino buildings, or another type of property operating slot machine games. In some instances, a single player loyalty server can service multiple casino properties. The depicted software elements preferably run on kiosk and server machines connected on a secure gaming network, and access cloud services through an internet gateway from the secure gaming network. Separate network links may implement the player loyalty system 800 and in-money slot machine gaming traffic, especially where regulations require such separation.

The on-premises components 804 include a player loyalty kiosk 806 (typically there are multiple player loyalty kiosks in an on-premises system) and a player loyalty server 808, both of which can be used in some embodiments without the cloud/hosted components 802. Player loyalty server 808 generally tracks all data and manages all player related data including enrollment, participation tracking, promotions, awards, and loyalty gaming, while the player loyalty kiosk handles player interaction and presentations of these functions. It is noted that some loyalty system functions may also be provided through an application on the casino slot machines themselves.

Single Page Application (SPA) 810 in this embodiment is run on a webview 814 executed on player loyalty kiosk 806 and communicates with the content management service 840 of player loyalty server 808, providing a dynamic and responsive web application user interface to player loyalty kiosk 806 without the need for page reloading in webview 814. SPA 810 communicates with a Framework services 816, which provide the necessary libraries and services for operating SPA 810 to implement the various loyalty functions available through the kiosk, including loyalty gaming as described herein.

Loyalty games provided through Player loyalty kiosk 806 each include a game application 812, which runs on webview 814 for handling graphics and system interactions to provide the core functionalities and mechanics for the games. In other embodiments, a custom script execution engine may be used rather than webview 814. Game application 812 may be a script or a compiled application. In this embodiment, game application 812 provides the interactive gaming interface is an HTML5/Javascript application and accesses the various services of player loyalty server 808 through API calls provided by APIs registered with the O/S by framework service 816. In other embodiments, the game application and game engine may instead run on player loyalty server 808 and provide the interactive gaming interface through SPA 810.

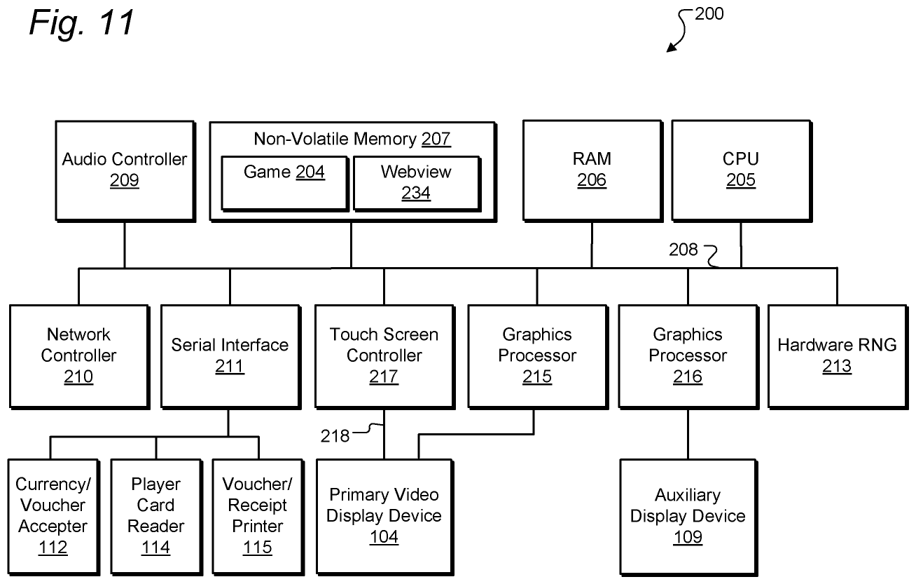

Base Application 818 runs on the Player loyalty kiosk 806, managing the overall operations and interactions of the kiosk, including interaction with the hardware components. Universal Hardware Controller (UHC) 822 is included to manage the communication between the Base App and the hardware components, such as printers, card readers, and scanners. This controller interacts with a System Operating Panel (SOP) 824, which provides the front-end administrative user interface to Player loyalty kiosk 806, allowing technicians to remotely access various functionalities such as pulling logs, restart the kiosk, run tests and restart a specific software or hardware component without having to bypass the security layer. The Operating System (O/S) and Drivers 826 run on the Player loyalty kiosk 806 and manage the hardware and software interactions, including memory interactions. PC/Peripherals 828 are the hardware components of the Player loyalty kiosk 806 including the electronic controller peripheral devices as further described below with respect to FIG. 10 and FIG. 11. Security layer 830 is an application on the Player loyalty kiosk 806 that ensures secure operations and interactions. It monitors application launches, nonvolatile memory accesses, updates, and other interactions such as API calls to ensure security and regulatory rules are met.

Player loyalty server 808 is also part of the on-premises infrastructure, although in some deployments a single player loyalty server 808 can serve multiple premises of a single casino operator entity. This is preferably done over a private network or VPN, which is treated like a single premise in the discussion herein.

Player loyalty server 808 hosts the Trilogy Platform application layer 809, which includes is an overall umbrella loyalty solution performing enrollment, loyalty tracking, loyalty rewards, promotions, slot tournament and promotional tournament enrollment, and slot account financial management including deposits and withdrawals. The depicted trilogy platform application layer 809 functions to provide a configuration and operation interface for the depicted applications and services 840-846, performs enrollment functions to add new players, and receives remote API calls from framework services 816, both procedural requests and data requests, and fulfills them by accessing the relevant application(s) or service(s) running on player loyalty server 808.

In this embodiment, the Trilogy platform 809 has several applications, including Content Management service 840, Tournament Event (“TournEvent”) application 841, Play Maker application 842, “Quik Draw” service 843, Redemptions service 844, Offers application 845, and Promotions service 846. Content management service 840 is a web service application running on the Player loyalty server 808. It manages the content displayed on the Player loyalty kiosk 806 through SPA 810 and other applications. It is able to access the other applications on player loyalty server 808 to fulfill all player interactions with the loyalty system through player loyalty kiosk 806. The TournEvent service 841 manages and organizes slot machine and gaming tournaments, including performing enrollment, tournament play tracking, and awards. Play Maker application 842, provides tools and functionalities for creating and managing gaming experiences. Quik Draw service 843 is also hosted on Player loyalty server 808, offering jackpot draw and award capabilities for any loyalty games or promotions that include jackpot prizes. Redemptions service 844 tracks and manages redemptions of accumulated player loyalty points for items such as free play (using points to play in-revenue games), complimentary services (redeeming points for free or discounted hotel stays, meals, show tickets, etc), gifts and merchandise (using points to get items from the casino's gift shop or partner stores), cash back (converting points into cash or credit to be used in the casino) or other available redemptions. Offers application 845 is included to provide players with various offers and promotions. Promotions service 846 manages and organizes promotional activities and campaigns.

Player loyalty server 808 also interacts with an Everi Patron Gateway application (EPG) 850, which runs on a separate server and provides a patron integration layer that keeps regulated data relating to in-revenue gaming separate from loyalty application data, while allowing the loyalty system to access the regulated data. Additionally, a Jackpot Express application 852 runs on a Jackpot Express kiosk for managing and distributing jackpot winnings, combining a mobile application interface for patrons, secure payment, tax forms management and anti-money laundering tracking into a single solution for jackpot payouts.

Cloud/hosted components 802 are run on servers in a data center external to the premises, referred to simply as “cloud”, which may be a hosted data center or a dedicated data center. Components 802 are employed in this embodiment to provide certain external services in a more efficient manner. In other embodiments, the various depicted components may instead be hosted on-premises and not cloud-based. Because of the nature of the components 802, specifically the fact that they are part of the Loyalty system and not in-revenue gaming, and the fact that they include interfaces to a third party system or external network, they are more efficiently provided as cloud services.

All these cloud/hosted components 802 are interconnected through the Trilogy Go Connector 860, which serves as an extension of the Trilogy Platform to third-party digital platforms, providing API endpoints for data ingestion and content display.

Player Activity Aggregation Service (PAAS) 870 is hosted in the cloud, which is a system that continuously processes the data stream of player activity, producing query-optimized results for transferring player activity data to the other functional blocks as needed. Specifically, PAAS 870 collects and aggregates patron play activity and patron non-play activity from multiple gaming and gaming related systems such as Vi service 871, in-casino player tracking systems, payments systems. PAAS 870 also provides query mechanisms for other the components such as the Trilogy platform 809 and customer analytic systems to easily query data that otherwise would be challenging to track across various system components.

The Vi™ service 871 is a mobile gaming service providing on-premises in-revenue mobile gaming. Vi service 871 in this embodiment includes Spark™ Remote Game Server and digital mobile games available from Everi Games, CashClub Wallet™ player currency account system available from Everi Games, and mobile technology solutions to enable mobile gaming on premises beyond the casino floor within a geographical footprint allowed by regulatory authorities. Vi service 871 may provide mobile gaming capability for player loyalty games in the Player Loyalty System herein, and allows mobile access to promotions and redemptions.

Mobile Gateway 872 is also hosted in the cloud, facilitating secure and efficient communication between mobile devices and the system for use of the Vi service 871 and mobile functionality for the player loyalty system. A Third Party Mobile Gateway 873, which enables integration with external mobile platforms. A Sports Radar 874 service is included to provide real-time sports data for in-revenue sports wagering, enhancing the gaming experience with up-to-date information. Payouts Network 875 manages financial transactions and payouts for in-revenue gaming. Gift and Go 876 service is hosted in the cloud, allowing players to redeem rewards and gifts seamlessly.

FIG. 9 shows a flow diagram of a process for operating a player loyalty kiosk to provide a loyalty game player interface according to some embodiments. The depicted process is one implementation suitable for providing the game interface described above with respect to FIG. 1-FIG. 8. In other embodiments, the process may be performed on a slot machine style electronic gaming machine and may be used to provide cash value results.

The process is initiated at block 902 when a patron clicks on a promotion tile of their user interface through the Player loyalty kiosk or player loyalty mobile application. Only loyalty games for which the patron's status, in points or otherwise, qualifies them are shown as available through the tile interface for launching.

In block 904, responsive to block 902, the loyalty game application files for the selected loyalty game are loaded to the webview (814, FIG. 8) or other local script execution engine. Subsequently, in block 906, a Promotion Status Application Programming Interface (API) is called to check the status of the promotion. A decision is made in block 908 to determine if the call to the Promotion Status API was successful. If the call is not successful, the process proceeds to block 918 where an error or default asset is thrown, followed by a timeout in block 920, and then exits the promotion in block 954.

If the call to the Promotion Status API is successful, the process at block 908 continues to block 910 where a Get Prizes API is called to retrieve prize data for the promotional game being played. This call returns all the prizes available in the promotion and whether they are available to win for the present player in the present game. Next, in block 912, another decision is made to determine if the call to the Get Prizes API was successful. If the call is not successful, the process proceeds to block 918 where an error or default asset is thrown, followed by a timeout in block 920, and then exits the promotion in block 954. If the call to the Get Prizes API is successful, the process proceeds to block 914 where the system enters a wait state and waits for player input. In block 916, a decision based on whether the player input was received successfully. If the player input is not received, the process proceeds to block 918 where an error or default asset is thrown, followed by a timeout in block 920, and then exits the promotion in block 954.

If the player input is received successfully, the process proceeds to block 922 where it makes an API call for activating participation in the promotion previously selected at block 902. An example of this activation is shown in the progression from FIG. 5 to FIG. 6A, during which progression the first player input is received on button 55. A label “TAP” or “START” indicates the button acts as a start button to receive the first player input in FIG. 5. Then in FIG. 6A the button is changed to say “Keep Tapping” to indicate that the continued rate of tapping is used in the game as discussed below.

In block 924, if the participate in promotion API call is successful, the process goes to block 926 where it retrieves winning prize data. A game result, with an associated losing or winning outcome and a prize, are preferably selected at this step for display. An animation for presenting a designated winning or losing result may be selected at this stage, or the game application may generate such an animation dynamically as the game proceeds. If the call was not successful, the process proceeds to block 918 where an error or default asset is thrown, followed by a timeout in block 920, and then exits the promotion in block 954.

After block 926, the process goes to block 928 where the system enters a “rapid tap” state, shown in FIG. 6A-FIG. 6F, in which a rate of player inputs or taps on button 55 is tracked over time to determine a beats-per-minute (BPM) or other suitable rate measurement such as taps per second. In block 930, a decision is made to determine if tapping is done. Preferably, this step checks if the game has progressed to near a defined end point at which player tapping can no longer affect a moving element. For example, the progress of a moving element past a certain defined point along a path may be used to determine if tapping is done. The moving element used for such a determination may be one directly affected by the tapping, such as the first “treasure” moving element 54 in the example of FIG. 6A, or another, second, moving element such as the second “shark” moving element 56. The progress to a selected point of a designated animated display selected to present the game result may also be used to determine if tapping is complete. This determination does not typically determine if the player has actually stopped tapping, because a new player tap may occur at any time. If tapping is not done, the process proceeds to block 932 where another decision is made to determine if player input is received. If player input is not received, the process proceeds to block 934 where the click or tap history is updated by saving some data indicating the time of the most recent tap, followed by block 936 where the Beats Per Minute (BPM) is updated based on the time of the most recent tap.

Then, at block 938, animated effects in the game are played based on the current BPM. The process then loops back to block 930. In the embodiment depicted in FIG. 6A-FIG. 6H, the animated effects of the first moving element 54 and second moving element 56 are played based on the measured BPM. The speed of the overall animation is adjusted in this embodiment until a designated point, such as when the first moving element reaches a designated location. In other embodiments, the velocity of the first moving element 54 is adjusted based on the BPM. The velocity of the second moving element 56 may also be adjusted based on the BPM, for example such that the shark is seen to chase the treasure chest faster if the chest is being hauled in faster. In other embodiments, more moving elements such as, for example, three, four, or five, elements have their velocity or other visible animated effect change based on the measured BPM. In some embodiments, every moving element in an animated scene may have some visible change based on the measured BPM.

If no player input is received at block 932, the process goes to block 940 where a decision is made to determine if BPM deterioration should start. If BPM deterioration should not start, the process loops back to block 930. If BPM deterioration should start, the process goes to block 936 where it adjusts the BPM rating lower based on a designated deterioration rate or a deterioration curve. The depicted process of BPM deterioration has the effect of allowing an increase in the rate of player inputs to immediately effect the animated velocity effects discussed above that are based on the BPM, while a decrease in the rate of player inputs does not immediately slow down the animated velocity effects. Use of these steps causes the process perform a time decay adjustment of the player input rate measurement such that the velocity of the first moving element decelerates more slowly than a slowdown in the player input rate measurement of BPM, such that the first moving element may appear to “coast” and slow gradually rather than immediately change to a slower velocity when the rate of player inputs, the tapping, slows down. The determination of whether BPM should deteriorate may be based on a time delay applied to downward changes in the BPM, a filter, or other suitable method to achieve this effect. A curve may be applied to the time delay to simulate coasting. For example, the first reduction of BPM may have a smaller value than the second reduction of BPM. Other moving elements may also have a similar effect based on the BPM.

Referring back to block 930, if the tapping is done at this step, the process goes to block 942 where a decision is made to determine if the prize is a winner. If the prize is not a winner, the process proceeds to block 944 where lose effects are played based on the current BPM, followed by block 946 where a player lose effect or lose prize screen is shown, and then block 952 where post-award effects are shown.

If the prize is a winner in block 942, the process proceeds to block 948 where animated win effects are presented, for example those shown in FIG. 6G-FIG. 6H. The effects may be based on the current BPM value during the presentation. Then at block 950, a win prize screen is shown (FIG. 7) and then block 952 where post-award effects are shown.

While a sequential flowchart is shown to describe an example process, this is not limiting and other programming logic may be used to achieve the functionality described. For example, an object oriented design, or similar event driven design may be used, in which user input and game process events cause software objects to perform tasks in response.

FIG. 10 shows a front perspective view of a player loyalty kiosk 1000 which includes a cabinet 101 having a front side generally shown at reference numeral 102. Player loyalty kiosk 1000 is one suitable implementation of a gaming machine for providing the gaming interface described above with respect to FIG. 1-FIG. 9. In this embodiment, the gaming interface provides a game with rewards of loyalty points such as free play points, which are provided by the player loyalty system and provide free play of with a single credit value per point, but cannot be redeemed for money. In other embodiments, a gaming machine such as a slot machine may be used, and the gaming interface may be used to provide a credit play game for cash value credit awards, or a points game for point awards having no cash value.

Player loyalty kiosk 1000 includes a display system including one or more display devices such as video displays. In the depicted version, the display system includes a primary video display device 104 which is mounted in an upper portion of the front side 102. Player loyalty kiosk 1000 also includes a lower auxiliary display device 109. Either or both of the display devices 104 and 109 may include touchscreen sensors. Either or both of display devices 104 and 109 may be used to present the gaming interface described above, and either or both may be used to present touchscreen controls for interfacing with a player loyalty system and for providing a gaming interface as described above. It should also be noted that each display device referenced herein may include any suitable display device including a cathode ray tube, liquid crystal display, plasma display, LED display, or any other type of display device currently known or that may be developed in the future.

Player loyalty kiosk 1000 may also include a number of other player interface devices in addition to devices that are considered player controls for use in playing a particular game. Player loyalty kiosk 1000 also includes a currency/voucher acceptor 112 having an input ramp, a player card reader having a player card input 114, and a voucher/receipt printer having a voucher/receipt output 115. In some embodiments, player loyalty kiosk 1000 also includes a currency dispenser 116, allowing kiosk 1000 to function as an ATM and/or a ticket-in-ticket-out (TITO) kiosk for redeeming player credits for currency. A near field communications (NFC) reader (not shown) may also be included on front face 102 for reading credit cards, debit cards, and/or player loyalty membership cards. One or more of these devices provides a credit input device in communication with the kiosk's controller and adapted for accepting a physical item associated with a monetary value that establishes a player credit balance.

FIG. 11 shows a hardware and logical block diagram 200 of player loyalty kiosk 1000 which includes processing system with a central processing unit (CPU) 205 that acts as a controller and may include one or more electronic processors. The processing system also includes a random access memory 206 and nonvolatile memory or storage device 207. All of these devices are connected on a system bus 208 with an audio controller 209, a network controller 210, and a serial interface 211. A graphics processor 215 is also connected on system bus 208 and is connected to drive primary display device 104 (mounted in cabinet 101 as shown in FIG. 10). A second graphics processor 216 is connected on system bus 208 in this example to drive the auxiliary display device 109 also shown in FIG. 11. Player loyalty kiosk 1000 also includes a touch screen controller 217 connected to system bus 208. Touch screen controller 217 is also connected via signal path 218 to receive signals from a touchscreen element associated with primary video display device 104. Another touch screen controller may also be included to receive signals from display 109. It will be appreciated that the touchscreen element itself typically comprises a thin film that is secured over the display surface of primary video display device 104. The touchscreen element itself is not illustrated or referenced separately in the Figures. Serial interface 211 provides communication from CPU 205 to currency/voucher acceptor 112, player card reader having a player card input 114, voucher/receipt printer having a voucher/receipt output 115, and currency dispenser 116 (if a currency dispenser is included).

Those familiar with data processing devices and systems will appreciate that other common electronic components will be included in player loyalty kiosk 1000 such as a power supply, cooling systems for the various system components, audio amplifiers, and other devices that are common in gaming machines. These additional devices are omitted from the drawings so as not to obscure the present invention in unnecessary detail.

Elements 205, 206, 207, 208, 209, 210, 211, 215, 216, and 217 shown in FIG. 11 are known elements used in the loyalty kiosk industry. These elements are preferably mounted in a computer chassis which is housed in cabinet 101 shown in FIG. 10. Alternatively, the various electronic components may be mounted on one or more circuit boards or modules housed within cabinet 101 without a separate enclosure. Those familiar with data processing systems and the various data processing elements shown in FIG. 11 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 11 as being connected directly on system bus 208 may in fact communicate with the other system components through a suitable expansion bus. Audio controller 209, for example, may be connected to the system via a PCI bus. System bus 208 is shown in FIG. 11 merely to indicate that the various components are connected in some fashion for communication with CPU 205 and is not intended to limit the invention to any particular bus architecture. Numerous other variations in the gaming machine internal structure and system may be used without departing from the principles of the present invention.

Although separate graphics processor 215 is shown for controlling primary video display device 104, and graphics processor 216 is shown for controlling both auxiliary display device 109, it will be appreciated that CPU 205 may control all of the display devices directly without any intermediate graphics processor. The invention is not limited to any particular arrangement of processing devices for controlling the video display device included with player loyalty kiosk 1000. Also, a player loyalty kiosk or gaming machine implementing the present invention is not limited to any particular number of video display devices or other types of display devices.

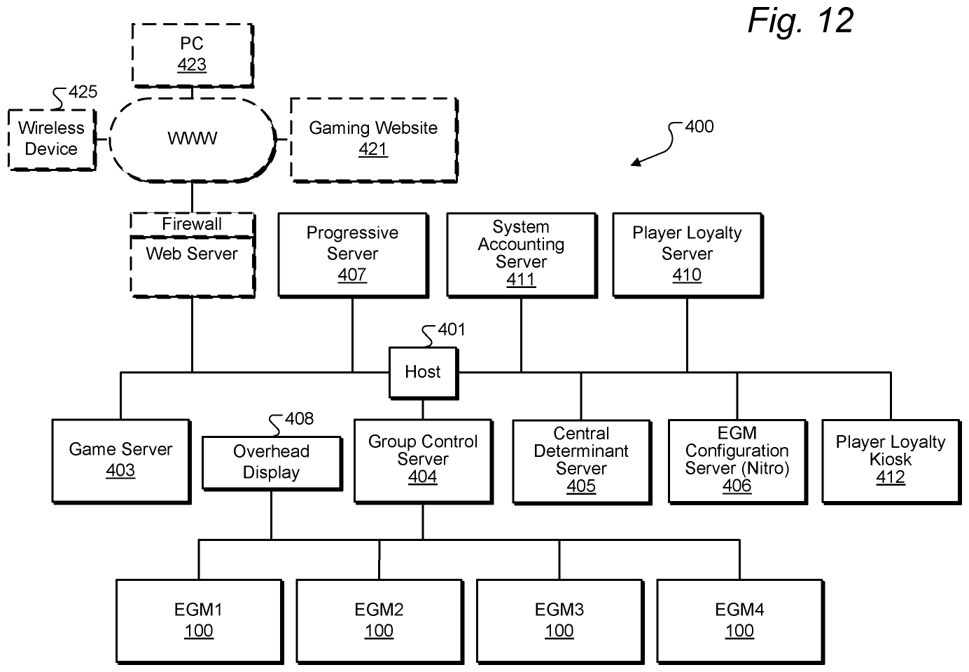

In the illustrated player loyalty kiosk 1000, CPU 205 executes a player loyalty interface application 234 which ultimately controls the player loyalty kiosk including normal tracking and accounting functions of a player loyalty kiosk such as voucher printing and reading, card reading, currency dispensing (if included), loyalty system enrollment, interfacing with player loyalty server 409 and player account server 410 (FIG. 12) to handle player credit balance transactions and obtain and distribute loyalty rewards such as free various rewards, such as complimentary meals, free play, hotel stays, show tickets, merchandise. CPU 205 controls receipt of player inputs and the presentation of the gaming interface according as described above through one or both of the display devices 104 and 109. As will be discussed further below, CPU 205 either alone or in combination with graphics processor 215 may implement a presentation controller for performing functions associated with a loyalty game 204 made available through the kiosk, and may also implement a game client for directing one or more display devices at the gaming machine to display the gaming interface according to the present invention. CPU 205 also executes software related to communications handled through network controller 210, and software related to various peripheral devices such as those connected to the system through audio controller 209, serial interface 211, and touch screen controller 217. Random access memory 206 provides memory for use by CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included.

It should be noted that the invention is not limited to player loyalty kiosks employing the arrangement of processing devices and interfaces shown in example gaming machine 100. Other kiosks or gaming machines through which the features herein are implemented may include one or more special purpose processing devices to perform the various processing steps for implementing the present invention, such as generating random numbers or checking the security status of software packages or gaming credit vouchers. Unlike processing devices such as CPU 205, these special purpose processing devices may not employ operational program code to direct the various processing steps.

Still referring to the hardware and logical block diagram 200 showing an example design for player loyalty kiosk 1000, the depicted player loyalty kiosk in operation is controlled generally by CPU 205 which stores operating programs and data in non-volatile memory or storage device 207 including game module 204, a webview application 234 which execute the game module, and software or drivers for touch screen controller 217, network controller 210, audio/visual controllers, the devices on serial interface 211. In some embodiments, a hardware random number generator (RNG) 213 is included. RNG 213 is employed if software RNG technology is not allowed in a particular gaming jurisdiction, or if a hardware RNG is preferred for security or improved gaming functionality. Either hardware RNG 213 or a suitable software RNG are employed for making the random selections of game outcomes when operating the game as described herein.

The game module 204, once installed, is held in non-volatile memory 207 of the kiosk. CPU or CPU 205 may be implemented as a conventional microprocessor, such as an Intel microprocessor, mounted on a printed circuit board with supporting ports, drivers, memory, software, and firmware to communicate with and control kiosk operations through the execution of coding stored in non-volatile memory or storage device 207. As shown, one or primary game modules 204 are included, containing executable code and data structures, including a game script or executable for performing the game, gaming interface data structures for providing the gaming interface as depicted above, and outcome data structures for providing game outcomes used by the game module in presenting awards through the gaming interface. In operation, game module 204 executes a process such as that of FIG. 9.

CPU 205 also connects through network controller 210 to a gaming network, such as example casino server network 400 shown in FIG. 12, including a player loyalty system. In some embodiments, separate logical or physical networks may implement the player loyalty system and the gaming network for security reasons.

FIG. 12 shows an example casino server network 400 according to some embodiments. Casino server network 400 may be implemented over one or more site locations and include host server 401, and an EGM configuration server 406 (in the preferred version the Everi Games Nitro Host server) for managing the configuration of multiple EGMs 100 on the network. A group display device 408 is coupled to casino server network 400 may include its own controller and graphics processor for driving a group display for a designated group of EGMs 100 in response to commands received over a network connection. The network may also include remote game play server 403 (which may be configured to provide game processor functionality including determining game outcomes and providing audio/visual instructions to a remote gaming device), a group control server 404 (which controls the gaming mode of the group of gaming machines including determining when to change the gaming mode and controlling the meters in the second gaming mode), central determinant server 405 (which may be configured to determine lottery, bingo, or other centrally determined game outcomes and provide the information to networked gaming machines 100 providing lottery and bingo-based wagering games to patrons), a progressive server 407 (which may be configured to accumulate a progressive pool from a portion of wagering proceeds or operator marketing funds and to award progressive awards upon the occurrence of a progressive award winning event to one or more networked gaming machines 100), player loyalty server 410 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator).

Player loyalty server 410 operates together with one or more player loyalty kiosks 412 and player loyalty tracking software running on each of EGMs 100 to provide a player loyalty system. The player loyalty kiosk depicted in FIG. 10 and shown in block diagram form in FIG. 11 is suitable for use as player loyalty kiosk 412.

Player loyalty server 410 may maintain player account records, and store persistent player data such as accumulated player points and/or player preferences. For example, the player tracking display may be programmed to display a player menu that may include a choice of personalized gaming selections that may be applied to a gaming machine 100 being played by the player. Player loyalty server 410 also provides an operator interface for configuring and providing loyalty rewards and promotions.

Through player loyalty kiosks 412, a player interface is provided to the loyalty system. Generally, the player interface provides enrollment functionality, account information, reward and promotion eligibility and distribution to the player, loyalty games, and other player loyalty system features. The enrollment features include the ability join enrollment groups or promotions for which the player may qualify. Player loyalty server 410 manages and provides the various prizes and promotions available through the player loyalty system through network communication with player loyalty kiosks 412 and EGMs 100. A website interface may also be provided in gaming website 421 for a player to manage their enrollment, enrollment groups, view their account information, and claim rewards and promotions available to them, including participation in loyalty games like that described herein.

Various rewards and promotions may be available through the player loyalty system including prizes, coupons and vouchers, “comps” (free services and products), loyalty point multipliers, slot machine free play credits, drawing entries, and promotional event enrollment, for example. Loyalty games provide an interactive gaming interface through which some or all of such rewards and promotions are made available. In the gaming interface described herein, for example, game prizes may provide slot machine free play credits that a player has earned through loyalty points or other participation such as regular (daily, weekly) play. Other rewards and promotions such as those listed above may also be provided through the gaming interface described herein.

While a player loyalty system including player loyalty kiosks is described, certain player loyalty functionality may also be implemented on EGMs 100. In one or more embodiments, the player loyalty menu may be programmed to display after a player inserts a player card into the card reader of an EGM 100. When the card reader is inserted, an identification may be read from the card and transmitted to player loyalty server 410. Player loyalty server 410 transmits player information through network controller 210 for presenting player loyalty functionality on the display and user interface of the EGM 100. The player tracking display may provide a personalized welcome to the player, the player's current player points, and any additional personalized data and options for launching loyalty games and claiming rewards and promotions. In this embodiment, the player loyalty interface and gaming interface for loyalty games are presented by the player loyalty kiosk.

Through its network connection, an electronic gaming machine (EGM) 100 may be monitored by an operator through one or more servers to implement networked functions such as to assure proper operation, and, data and information may be shared between gaming machine 100 and respective of the servers in the network such as to accumulate or provide player loyalty points, to provide server-based games, or to pay server-based awards. While some of the servers have been shown separately, they may be combined or split into additional servers having additional capabilities.

As shown, networked electronic gaming machines 100 (EGM1-EGM4) and one or more overhead group displays 408 may be network connected and enable the content of one or more displays of gaming machines 100 to be mirrored or replayed on an overhead display. EGMs 100 may also feed celebration graphics directly to the overhead displays 408 in the course of providing games, for example to show a celebration for a large bonus win or group gaming mode win on a particular EGM 100. Typically the overhead display function and group celebration scenarios are managed by a floor messaging server such as Nitro floor messaging server 404, which receives messages from EGM's 100 to communicate group gaming mode wins, bonus game wins, or awards of other large prizes such as progressive prizes.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

In one or more embodiments, a gaming website may be accessible by players, e.g. gaming website 421, through which various features of the player loyalty system herein are made available to patrons.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A player loyalty system for a slot machine network comprising:
a player loyalty server operable to track player loyalty points on the slot machine network, provide awards and promotions accessible through a player loyalty interface, and provide player loyalty game results accessible through a gaming interface of the player loyalty interface;
a player loyalty kiosk coupled to the player loyalty server over a network, and including a controller, a touchscreen display system coupled to the controller, a player card reader coupled to the controller, and one or more tangible non-transitory computer readable media holding a program product containing instructions for controlling operation of the player loyalty kiosk, the instructions operable for:
presenting an option through the touchscreen display to launch a player loyalty game, and responsive to a launch input entered through a gaming interface of the player loyalty kiosk, causing a display system of the player loyalty kiosk to display the gaming interface including an animated game effect in a first area of the display system with one or more moving elements;
responsive to a player input, adjusting a player input rate measurement based on a rate of player inputs over time; and
adjusting a velocity of a first one of the moving elements based on the player rate input measurement and adjusting a conclusion of the animated game effect based at least in part on the movement of said adjusted moving element.

2. The player loyalty system of claim 1 wherein adjusting the velocity of the first moving element is part of adjusting a speed of an overall animation of the gaming interface.

3. The player loyalty system of claim 1 wherein the instructions are further operable to perform a time decay adjustment of the player input rate measurement such that the velocity of the first moving element decelerates more slowly than a slowdown in the player input rate measurement.

4. The player loyalty system of claim 1 wherein there are two or more moving elements, and a velocity of a second one of the moving elements is adjusted based on the player rate measurement.

5. The player loyalty system of claim 4 wherein the instructions are further operable for providing the first moving element with a base velocity which is used in the animated game effect if the player input rate measurement is zero.

6. The player loyalty system of claim 1 wherein the instructions are further operable for displaying a start button and responsive to a press of the start button changing the start button to a player input button, activations of which form the basis of the player input rate measurement.

7. The player loyalty system of claim 1 wherein the instructions are further operable for accessing a player loyalty server to obtain a total prize amount in free play credits for the game result, and selecting a game result presenting the prize amount from among a number of game results.

8. A method for controlling operation of a player loyalty kiosk, the method including:
responsive to a game launch input entered through a user interface of the player loyalty kiosk, causing a display system of the player loyalty kiosk to display a gaming interface including an animated game effect in a first area of the display system with one or more moving elements;
responsive to a player input, adjusting a player input rate measurement based on a rate of player inputs over time; and
adjusting a velocity of a first one of the moving elements based on the player rate input measurement and adjusting a conclusion of the animated game effect based at least in part on the movement of said adjusted moving element.

9. The method of claim 8 wherein adjusting the velocity of the first moving element is part of adjusting a speed of an overall animation of the gaming interface.

10. The method of claim 8 further comprising performing a time decay adjustment of the player input rate measurement such that the velocity of the first moving element decelerates more slowly than a slowdown in the player input rate measurement.

11. The method of claim 8 wherein there are two or more moving elements, and a velocity of a second one of the moving elements is adjusted based on the player rate measurement.

12. The method of claim 8 further comprising providing the first moving element with a base velocity which is used in the animated game effect if the player input rate measurement is zero.

13. The method of claim 8 further comprising accessing a player loyalty server to obtain a total prize amount in free play credits for the game result, and selecting a game result presenting the prize amount from among a number of game results.

14. One or more tangible non-transitory computer readable media holding a program product for controlling operation of a player loyalty system including a player loyalty kiosk, the program product comprising machine readable instructions executable by a processing system for:
responsive to a game launch input entered through a user interface of the player loyalty kiosk, causing a display system of the player loyalty kiosk to display a gaming interface including an animated game effect in a first area of the display system with one or more moving elements;
responsive to a player input, adjusting a player input rate measurement based on a rate of player inputs over time; and
adjusting a velocity of a first one of the moving elements based on the player rate input measurement and adjusting a conclusion of the animated game effect based at least in part on the movement of said adjusted moving element.

15. The media of claim 14 wherein adjusting the velocity of the first moving element is part of adjusting a speed of an overall animation of the gaming interface.

16. The media of claim 14 wherein there are two or more moving elements, and a velocity of a second one of the moving elements is adjusted based on the player rate measurement.

17. The media of claim 14 wherein the instructions are further executable for:
providing the first moving element with a base velocity which is used in the animated game effect if the player input rate measurement is zero.

18. The media of claim 14 wherein the instructions are further executable for:
displaying a start button and responsive to a press of the start button changing the start button to a player input button, activations of which form the basis of the player input rate measurement.

19. The media of claim 14 wherein the instructions are further executable for:
accessing a player loyalty server to obtain a total prize amount in free play credits for the game result, and selecting a game result presenting the prize amount from among a number of game results.
